(19) United States
(12) Patent Application Publication
(10) Pub. No.: US 2013/0265438 A1
(43) Pub. Date: Oct. 10, 2013

(54) IMAGING APPARATUS, IMAGING METHOD, AND CAMERA SYSTEM

(71) Applicant: SONY CORPORATION, Tokyo (JP)

(72) Inventor: Toshinobu Sugiyama, Kanagawa (JP)

(73) Assignee: SONY CORPORATION, Tokyo (JP)

(21) Appl. No.: 13/804,696

(22) Filed: Mar. 14, 2013

(30) Foreign Application Priority Data
Apr. 9, 2012 (JP) 2012-088721

(51) Int. Cl. H04N 5/33

(52) U.S. Cl. CPC H04N 5/33
USPC 348/164

(57) ABSTRACT

An imaging apparatus includes: an imaging device that images an infrared image using reflected light from a subject to which infrared light is irradiated, and, in addition, images a color image using the reflected light from the subject to which patterns formed by combining a plurality of colors of visible laser light are projected; and a signal processing unit that colors the infrared image using color information which is determined depending on an intensity of the reflected light of the plurality of colors of visible laser light from the color image.

### FIELD

The present disclosure relates to an imaging apparatus, an imaging method, and a camera system which are appropriately used for a surveillance camera or a civilian camcorder, which performs night image capturing based on infrared light irradiation.

### BACKGROUND

A surveillance camera generally includes two functions, that is, a day mode to capture an image during the day, and a night mode to capture an image at night. The day mode is a capture function using a normal color. However, in the night mode, in order to capture an image in a dark environment at night, infrared light (infrared rays) is projected, and the reflected light thereof is captured. Therefore, even in an environment in which there is no light at all, it is possible to acquire a clear image (hereinafter, referred to as an infrared image).

However, unlike visible light capture, since it is not possible to acquire color information in the capture using infrared light, usually, it is general to display a monochrome image of a gray color or a green color in correspondence to the brightness of infrared light.

However, in a case of a surveillance camera, the purpose of it is to make the observation of a suspicious figure and a suspicious substance possible in a surveillance area. In order to identify them, the information about the color of the clothes of a person or the color of a vehicle is extremely important. However, if an image is captured in a normal color mode when it is dark like at night, noise and the signal intensity of a subject are at the same level, and thus it is difficult to discriminate these. In addition, when there is no ambient light at all as in a closed room, it is difficult to precisely capture an image. In order to capture a dark section, it is taken into consideration that, for example, visible light is irradiated like general illumination. However, generally, for the purpose of surveillance, in order to avoid creating nuisance in the neighborhood due to unnecessary illumination or to prevent a surveillance region from attracting attention, there are many cases in which visible light illumination is not used.

The above-described night mode using the infrared light irradiation has been used in order to solve the above problems. However, in an image which is acquired by the infrared light irradiation, while a clear image is acquired during the day, a monochromatic image in which it is difficult to determine the color of a subject is obtained.

In addition, besides the purpose of the surveillance camera, there is a digital video camera or a camcorder provided with a function of capturing an image when it is dark using infrared light irradiation. However, in these, there is a demand for adding color to an infrared image in order to acquire a natural image.

With regard to the above-described problems, as a method capable of adding a color to an infrared image even in a state in which there is no ambient light at all, there is a method disclosed in, for example, JP-A-2011-50049. This uses three types of infrared light having different wavelengths as projection infrared light, and presumes the color of a subject based on the difference between a reflective property depending on the material (resin) of infrared light and the reflective property of visible light. According to JP-A-2011-50049, for example, reflectivities depending on the resins of the three types of infrared light of 780 nm, 870 nm, and 940 nm respectively have positive correlations with the reflectivities of red, green, and blue visible light. Therefore, if each of the infrared reflected light is dispersed and received using such as a filter which is set in front of an image sensor and an image is colored in such a way that the intensity of each of the reflected light corresponds to red, green, or blue, it is possible to acquire a color image.

On the other hand, in the digital video camera, a method of reproducing a natural color in an image captured by projecting infrared light when it is dark has been proposed (for example, refer to JP-A-2005-130317). In this method, if a camera system detects that a mode enters a night mode, a parameter table which is used for white balance adjustment and which is different in a normal color imaging mode is used. Therefore, it is possible to perform appropriate color reproduction even in a state in which the visible light and the infrared light are mixed.

### SUMMARY

However, according to the technology disclosed in JP-A-2011-50049, red color has a high correlation with the infrared light and color reproducibility is comparatively appropriate. However, green color and blue color do not have clear correlation with infrared light. Therefore, it is difficult to reproduce an original color. In addition, the above-described resin shows the correlation between infrared light and visible light to some extent. However, there are materials other than resin, which it is difficult to acquire the correlation or which the correlation of the reflectivity between visible light and infrared light is different from that of resin. Therefore, it is difficult to perform color reproduction of a subject reflected in a camera based on uniform correlation.

In addition, in a method disclosed in JP-A-2005-130317, originally, color reproduction is possible only in a state where some visible light remains depending on an environment, and it is difficult to use the method in a scene where there is no ambient light. In addition, since visible light components are taken from a signal in which the infrared light and the visible light are mixed, it is difficult to increase color reproduction accuracy.

Thus, it is desirable to provide a method of adding a color to an image (monochromatic image) based on the infrared light irradiation when it is dark, that is, when ambient light is less with high accuracy.

According to an embodiment of the present disclosure, an imaging device images an infrared image using reflected light from a subject to which infrared light is irradiated, and, in addition, images a color image using the reflected light from the subject to which a pattern formed by combining a plurality of colors of visible laser light is projected. Further, a signal processing unit colors the infrared image using color information which is determined depending on an intensity of the reflected light of the plurality of colors of visible laser light from the color image.

According to the embodiment of the present disclosure, the projected pattern of the visible laser light corresponding to the plurality of colors (for example, three primary colors) is directly irradiated to the subject, and the reflected light intensity is detected, and thus the color information which is assigned to the infrared image is determined.

According to the embodiment of the present disclosure, it is possible to add a color to an image (monochromatic image) based on the infrared light irradiation when it is dark, that is, when ambient light is less with high accuracy.

### BRIEF DESCRIPTION OF THE DRAWINGS

FIG. 1 is a block diagram illustrating an example of the configuration of an imaging system according to a first embodiment of the present disclosure;

FIG. 2 is a schematic configuration diagram submitted to the description of a projector unit;

FIG. 3 is an explanatory diagram illustrating an example of a projected pattern which is generated via a hologram plate;

FIG. 4 is an explanatory diagram illustrating examples of an angle of view area and the projected pattern;

FIG. 5 is a sequence view illustrating an example of an operation of an imaging device according to the first embodiment of the present disclosure;

FIG. 6 is a block diagram illustrating an example of the internal configuration of a signal processing unit in a camera unit in FIG. 1;

FIG. 7 is a flowchart illustrating an example of a process to generate a single frame image in a camera system;

FIGS. 8A to 8E are explanatory diagrams illustrating respective stages for extracting the color of an intruder;

FIG. 9 is an explanatory diagram illustrating an example of detecting a closest laser pattern, which is in the same region which includes a pixel of interest of an infrared image, from a color image;

FIGS. 10A to 10C are explanatory diagrams illustrating a process to extract color information using a reduced color image according to a second embodiment of the present disclosure;

FIG. 11 is an explanatory diagram illustrating a camera system which extracts colors from an entire screen by scanning a laser pattern on an entire angle of view area according to a third embodiment of the present disclosure;

FIG. 12 is a configuration view illustrating an example of a projector unit according to the third embodiment of the present disclosure;

FIG. 13 is an explanatory diagram illustrating slit light which is generated via the hologram plate and an angle of view for image capturing; and

FIG. 14 is a sequence view illustrating an example of an operation of an imaging device according to the third embodiment of the present disclosure.

### DETAILED DESCRIPTION

Examples of forms used to implement the present disclosure (hereinafter, referred to as examples of the present embodiments) will be described with reference to the accompanying drawings. Meanwhile, in the specification and drawings, components which substantially have the same function and configuration are indicated using the same reference numerals, thereby redundant description is omitted.

Meanwhile, description will be made in the following order.

1. First Embodiment (Projector Unit: Example Using Projected Pattern Using Hologram Plate)

2. Second Embodiment (Signal Processing Unit: Example Using Reduced Color Image)

3. Third Embodiment (Scanning Unit: Example of Scanning Laser Pattern on Entire Surface of Angle of View Area)

4. The Others (Modification Example)

### 1. First Embodiment

### Example of Configuration of Entire Camera System

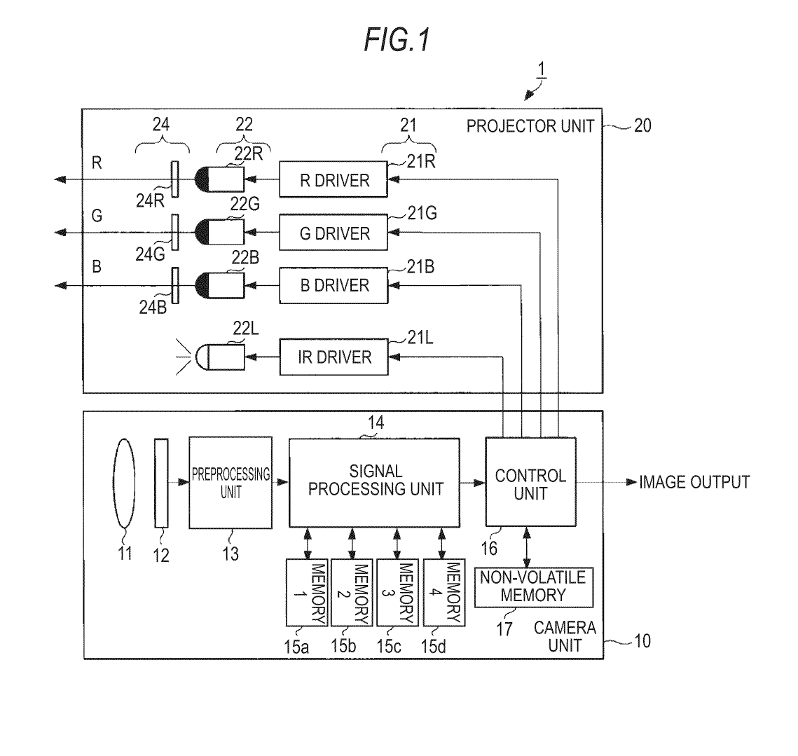

FIG. 1 is a block diagram illustrating an example of the configuration of a camera system according to a first embodiment of the present disclosure.

A camera system 1 according to an example of the embodiment includes a camera unit 10 (an example of an imaging apparatus) and a projector unit 20. The camera unit 10 includes, for example, a lens 11, an imaging device 12, a preprocessing unit 13, a signal processing unit 14, a control unit 16, and a non-volatile memory 17, like a normal camera.

The lens 11 collects light from a subject, and forms an image on the imaging surface of the imaging device 12. The imaging device 12 is an image sensor such as, for example, a Charge-Coupled Device (CCD) in which pixels each having a photoelectric conversion device for performing photoelectric conversion are two-dimensionally arranged, and provided with, for example, color separation filters (not shown) which are arranged in a mosaic form on the front surface thereof. That is, each of the pixels (photoelectric conversion devices) of the imaging device 12 generates an imaging signal (signal charge) by performing photoelectric conversion on image light of the subject, which is incident via the lens 11 and the color separation filter, and outputs the generated imaging signal (analog signal) to the preprocessing unit 13. The color separation filter divides incident light into, for example, red (R), green (G), and blue (B) light.

The preprocessing unit 13 includes, for example, a correlated double sampling circuit which removes the noise of the imaging signal output from each of the pixels of the imaging device 12, an A/D converter which converts an analog signal into a digital signal, and a demosaic processing unit which performs demosaicing.

The signal processing unit 14 is a processor for processing a signal, such as, for example, a Digital Signal Processor (DSP). An image process which will be described later is performed in such a way that a processor executes a predetermined program for digital image data (image signal) which is obtained through conversion and output from the preprocessing unit 13. The image-processed image data is temporally stored in first memory 15a to fourth memory 15d (described as memory 1 to memory 4 in the drawing) depending on each of stages. The details of the signal processing unit 14 will be described later. Meanwhile, the signal processing unit 14 may include the function of apart of the preprocessing unit 13, such as the demosaic processing unit.

In addition, the camera unit 10 includes a timing generator which is not shown in the drawing. The timing generator controls a signal processing system which is configured with the imaging device 12, the preprocessing unit 13, and the signal processing unit 14 such that the image data is incorporated with a predetermined frame rate. That is, an image data stream is provided to the signal processing unit 14 at the predetermined frame rate.

The control unit 16 is a block which controls the whole process of the camera unit 10, and outputs the image data output from the signal processing unit 14 to the outside. For example, a microcomputer is applied to the control unit 16. For example, when the camera system 1 is applied to a surveillance camera, the output is provided to an external monitor via an electric telecommunication line such as, for example, a LAN or the Internet. Otherwise, when the camera system 1 is applied to a civilian camcorder, the output is provided to a view finder. In addition, the control unit 16 can record the image data which is output from the signal processing unit 14 in the non-volatile memory 17. The signal processing unit 14, the first memory 15a to the fourth memory 15d, the control unit 16, and the timing generator which is not shown in the drawing are connected to each other via a bus (not shown).

On the other hand, the projector unit 20 includes an LED 22L for infrared light (IR) irradiation, laser light sources 22R, 22G, and 22B which correspond to red (R), green (G), and blue (B), and driver circuits 21R, 21G, and 21B which correspond to respective color laser light sources for driving. The LED 22L for infrared light irradiation is the same as an LED which is generally used for a surveillance camera. For example, semiconductor laser is used for the laser light sources 22R, 22G, and 22B. The driver circuits 21R, 21G, and 21B which correspond to the respective colors operate according to an instruction which is input from the control unit 16 of the camera unit 10.

Meanwhile, although the first memory 15a to the fourth memory 15d have been described as individual memories in the example shown in FIG. 1, the whole or a part of these memories may be configured as the same memory.

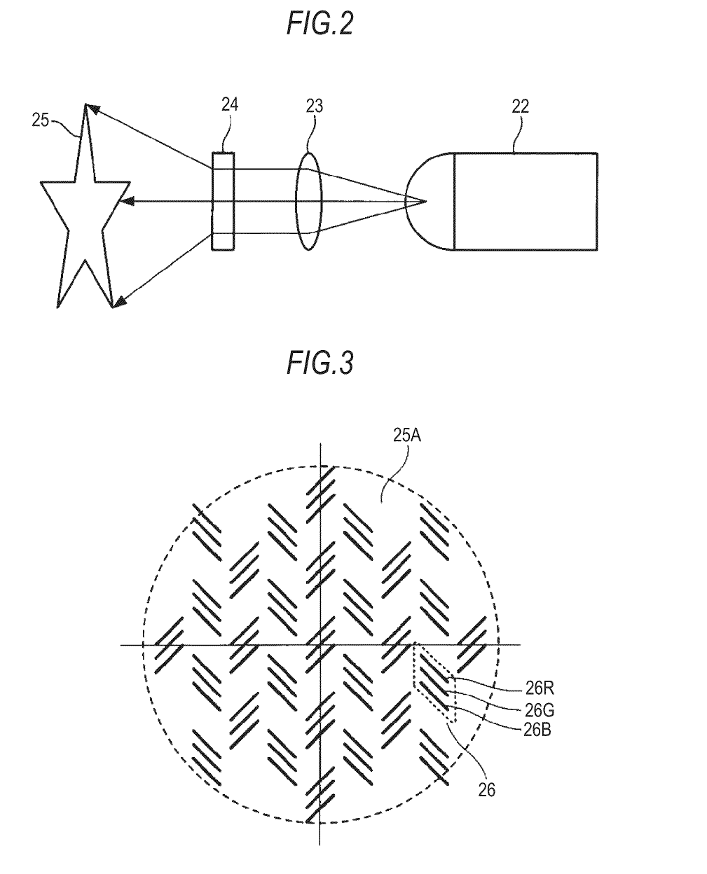

FIG. 2 is a schematic configuration diagram submitted to the description of the projector unit 20.

Although laser light output from the semiconductor laser which is used for the laser light sources 22R, 22G, and 22B (hereinafter, collectively referred to as a laser light source 22) is normal visible laser light, the hologram plate 24 is provided on a side of the output window of the laser light source 22. It is the same as in all the red color laser light source 22R, the green color laser light source 22G, and the blue color laser light source 22B.

The laser light which is output from the laser light source 22 is converted into parallel light by a former stage lens 23, and the parallel light is incident on the hologram plate 24 provided with hologram which uses the diffraction of light. The hologram plate 24 diffracts the laser light which is the parallel light using hologram, and dispersively irradiates the laser light using a specific pattern. The dispersively irradiated laser light is interfered with each other, and a so-called hologram reproduced image 25 (projected pattern) is reproduced. Therefore, it is possible to project the laser light (the hologram reproduced image 25) which is diffracted and dispersed to, for example, a subject in the optical axis direction of the lens 23. The use of the hologram plate of a camera system is described in, for example, JP-A-2002-237990.

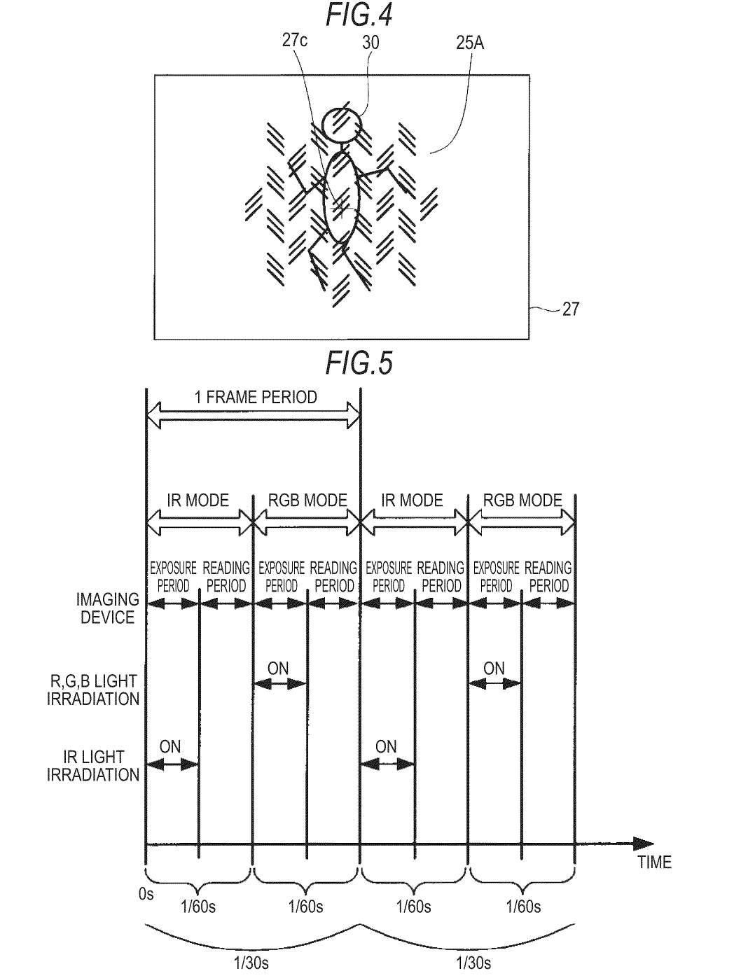

FIG. 3 is an explanatory diagram illustrating an example of the projected pattern which is generated via the hologram plate. In addition, FIG. 4 is an explanatory diagram illustrating examples of the angle of view area and the projected pattern.

Various types of patterns can be applied to the projected pattern, which is projected by the hologram plate, by designing a diffraction pattern. For example, a hologram reproduced image which is shown in FIG. 3 as a projected pattern 25A is reproduced in the example of the embodiment. A red color pattern 26R, a green color pattern 26G, and a blue color pattern 26B are patterns which are respectively generated using red color laser light, green color laser light, and blue color laser light. The diffraction pattern of laser light is actually projected as the arrangement of light spots. If design is made such that a plurality of color light spots are adjacent to each other and are arranged in an approximately straight line, it is possible to project the color light spots as segments as shown in FIG. 3. In the example of the embodiment, a unit pattern 26 is configured by arranging the respective segments of the red color pattern 26R, the green color pattern 26G, and the blue color pattern 26B to be adjacent, and the projected pattern 25A (hologram reproduced image) is formed by dispersively arranging a plurality of unit patterns 26.

In the example of the embodiment, a segment pattern is projected as a segment which is inclined by approximately 45 degrees in horizontal and vertical directions. It is possible to equally acquire color information in the horizontal and vertical directions by inclining the segment pattern by approximately 45 degrees. In addition, position adjustment is performed such that the projected pattern 25A configured with these segment patterns is irradiated in an entire angle of view area (captured angle of view) 27 which is captured by the camera unit 10 or at approximately central portion 27c of the angle of view area 27 as shown in FIG. 4. It is possible to detect the color of a subject (for example, an intruder 30) which appears at the approximately central portion 27c of the angle of view area 27 by irradiating the projected pattern 25A at the approximately central portion 27c of the angle of view area 27.

Meanwhile, the entire shape of the laser light projected pattern 25A is an approximately circle and the unit patterns 26 are dispersively arranged in a circle shown using a broken lines in the example shown in FIG. 3. However, the shape or the size of the projected pattern and the color of laser light may be appropriately changed depending on a surveillance target or an image-capturing target. It is preferable that at least one unit pattern of the projected pattern be dispersed to be included in the division region of the infrared image of a target when viewed from color reproduction. The division region indicates a single region of regions which are obtained by dividing the infrared image into a plurality of regions, and the details thereof will be described later.

### [Example of Operation of Imaging Device]

FIG. 5 is a sequence view illustrating an example of an operation of the imaging device 12 according to the first embodiment of the present disclosure.

In the example of the embodiment, a single frame period (for example, 1/30 sec) that the camera system 1 generates a single image (single frame) is divided into two which are respectively set to an IR mode and an RGB mode. The imaging device 12 performs scanning for a single screen in each of the IR mode and the RGB mode.

In the IR mode, as the same as image capturing at night (night mode) of a normal surveillance camera, an infrared image is captured using the imaging device 12 by irradiating infrared light (IR) to a subject.

First, infrared light is irradiated to the subject from LED 22L for infrared light irradiation during an exposure period (vertical blanking period), and each of the pixels (photoelectric conversion devices) of the imaging device 12 stores signal charge depending on the amount of received infrared light which is reflected on the subject. Further, in a reading period thereafter, the imaging device 12 performs a process to release the signal charge stored in each pixel over a single screen, and thus image data (infrared image) based on infrared light is generated. The infrared image which is generated by this capturing is stored in the first memory 15a shown in FIG. 1.

On the other hand, in the RGB mode, laser light having, for example, the projected pattern 25A shown in FIG. 4 is projected from the projector unit 20, and image capturing is performed by the imaging device 12.

First, laser light of each of the R, G, and B colors is output from the laser light sources 22R, 22G, and 22B of the projector unit 20 in an exposure period (vertical blanking period), and, for example, the projected pattern 25A shown in FIG. 4 is projected to the subject via each of the hologram plates 24R, 24G, and 24B. Each of the pixels of the imaging device 12 stores signal charge depending on the amount of received each color laser light which is reflected on the subject. Further, in a reading period thereafter, the imaging device 12 performs a process to release the signal charge stored in each pixel over a single screen, and thus image data (color image) based on laser light of each of the R, G, and B colors is generated. The color image which is generated by this capturing is stored in the second memory 15b shown in FIG. 1.

After the image capturing ends in the IR mode and the RGB mode during a certain single frame period, the camera system 1 performs image capturing in the IR mode and the RGB mode during a subsequent single frame period, and captures moving images by repeatedly processing these processes.

Meanwhile, in the camera system 1, an IR cut-off filter is generally arranged before the imaging device 12 when a color image is captured, and thus an operation which is excluded when the infrared image is captured is performed. However, in the example of the embodiment, since it is assumed that image capturing is performed when it is dark such as at night, the external light of infrared light is a little, and thus the IR cut-off filter may be usually excluded.

In addition, in the RGB mode, the reflectivity of the projected pattern of each of the R, G, and B colors which is projected to the subject differs in the color of the subject. It is set in advance such that the detection level of each reflected light is the same when the output of the laser light of each of the R, G, and B colors is irradiated to a white color subject. It is the equivalent operation to white balance adjustment.

### [Example of Internal Configuration of Signal Processing Unit]

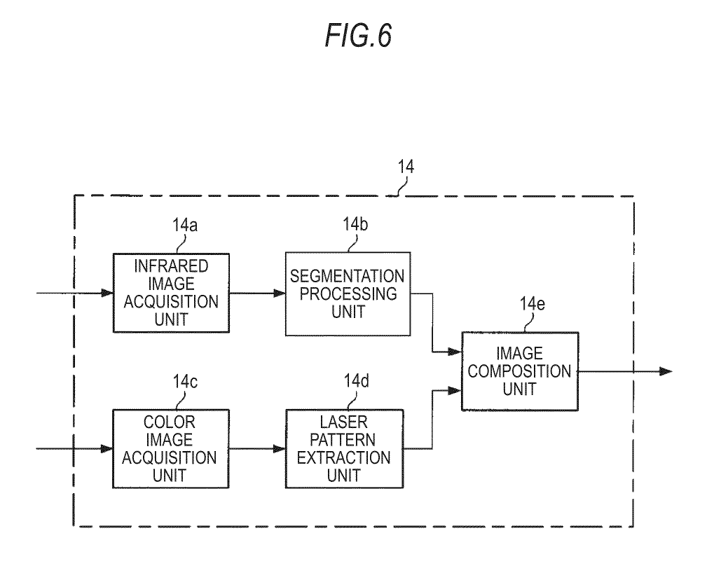

FIG. 6 is a block diagram illustrating an example of the internal configuration of the signal processing unit 14 in the camera unit 10 shown in FIG. 1.

The signal processing unit 14 mainly includes an infrared image acquisition unit 14a, a segmentation processing unit (region division unit) 14b, a color image acquisition unit 14c, a laser pattern extraction unit 14d, and an image composition unit 14e.

The infrared image acquisition unit 14a acquires the infrared image, which is generated along the sequence shown in FIG. 5, from the imaging device 12.

Here, region division will be described. The segmentation processing unit 14b performs a process to divide the acquired infrared image into a plurality of regions based on a predetermined condition (segmentation process). In the example of the embodiment, the infrared image is divided into a plurality of regions based on a signal level of an imaging signal (hereinafter, referred to as a signal value) which is output depending on the intensity of the reflected light of infrared light which is received by each of the pixels (photoelectric conversion devices) of the imaging device 12.

For example, it is assumed that the pixel array of the imaging device 12 is Bayer array. In this case, when the signal level of an R signal of an arbitrary pixel is defined as R, the signal level of a G signal is defined as G, and the signal level of a B signal is defined as B, the signal value (brightness value) of the pixel is acquired using a calculating formula expressed as: (R+2G+B)/4. A signal value is calculated using the calculating formula with regard to each pixel, and the region division is performed. Meanwhile, although a method of calculating the signal value of a pixel is described using the case of the Bayer array as an example, an imaging device which uses another array is not limited thereto.

The description with reference to FIG. 6. is revisited. The color image acquisition unit 14c acquires the color image, which is generated along the sequence shown in FIG. 5, from the imaging device 12.

The laser pattern extraction unit 14d acquires the intensity of the reflected light of the laser light of each color from the color image which is captured by the imaging device 12, and extracts a laser pattern.

The image composition unit 14e generates a composition image (composition color image) by assigning a color to the corresponding region of the infrared image which is at a position corresponding to the reflection pattern of the color image based on color information which is determined based on the intensity of the reflected light of the laser light of each color extracted by the laser pattern extraction unit 14d. The image composition unit 14e outputs the generated composition image to the control unit 16.

### [Example of Process to Generate Single Frame Image]

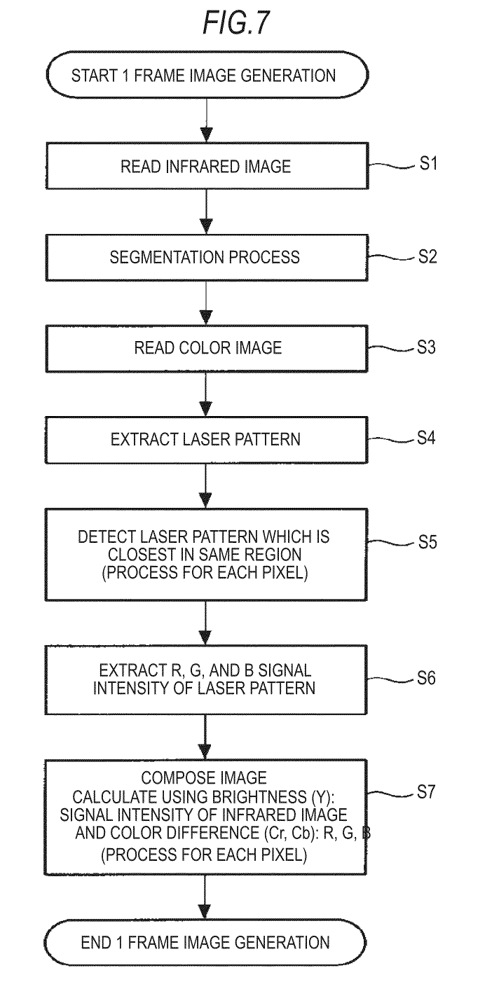

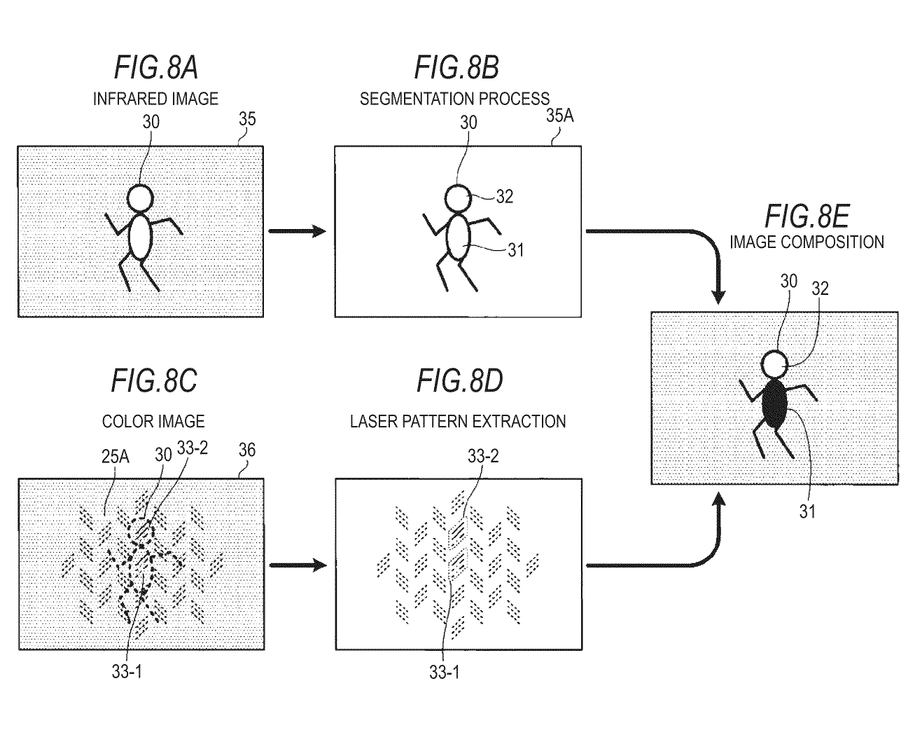

An example of a case in which the camera system 1 which is configured as described above is used to extract the color of an intruder will be described. FIG. 7 is a flowchart illustrating an example of a process to generate a single frame image in the camera system 1. In addition, FIGS. 8A to 8E are explanatory diagrams illustrating respective stages for extracting the color of an intruder.

When the intruder 30 gets taken in the angle of view area of the imaging device 12, the camera system 1 starts to capture the intruder 30. That is, the camera system 1 acquires two images of the infrared image and the color image in the successive IR mode and RGB mode within a single frame period according to the sequence shown in FIG. 5. The respective images of the infrared image and the color image are first stored in the respective first memory 15a and the second memory 15b in FIG. 1. Meanwhile, since a technology that starts to capture by using the appearance of the intruder 30 as trigger has been well known, the detailed description thereof is omitted.

In the signal processing unit 14, first, the infrared image acquisition unit 14a reads the infrared image from the first memory 15a (step S1).

In the infrared image, generally, a subject which is positioned at the front is captured brightly because infrared light is reflected, and a background is captured darkly because the reflected light is weak. An example of the infrared image is shown in FIG. 8A.

Subsequently, the segmentation processing unit 14b performs a segmentation process on the infrared image 35, and extracts the same subject or a region which is determined as the same position in the infrared image 35 (step S2).

Although various methods can be used as a method for the segmentation process, for example, a method of preparing a histogram of the signal value of each pixel of the infrared image 35, and blocking (dividing) into a plurality of areas based on the histogram of the signal value can be used. The signal value of a pixel corresponds to the intensity of the reflected light (signal intensity) of infrared light which is received in each pixel of the imaging device 12. It is possible to extract each region of the intruder 30 in the infrared image 35, such as, for example, a torso 31 or a head 32 by performing the segmentation process (FIG. 8B). An infrared image 35A, obtained after the segmentation process is performed on the infrared image 35 by the segmentation processing unit 14b, is written in the third memory 15c. In addition to the infrared image 35, the coordinates of a pixel for each region is included in the data of the infrared image 35A.

Subsequently, the color image acquisition unit 14c reads the color image 36, which is captured in a normal mode, from the second memory 15b (FIG. 8C) (step S3).

The color image 36 is captured in such a way that laser light having R, G, and B projected pattern 25A as shown in FIG. 4 is projected to a subject from the projector unit 20. Generally, in the capture at night, an imaging signal corresponding to the subject is emphasized by increasing the gain of an imaging signal which is output from the imaging device. In the example of the embodiment, it is not necessary to increase the gain of the imaging signal until the subject can be confirmed, and adjustment may be performed such that the pattern of light which is reflected on the subject to which laser light having a predetermined projected pattern is projected can be confirmed. Therefore, both a subject, such as the intruder 30, and a background are completely invisible or the outline thereof can be scarcely determined as the color image, as shown in FIG. 8C. In the laser pattern of the laser light which is projected to the subject, only the laser pattern of laser light which is reflected on the subject is brightly captured.

Meanwhile, since the gain of the imaging signal which is generated in the imaging device may not be increased, an amplifier is not necessary. In addition, power consumption of an amplifier or a circuit which includes an amplifier is reduced.

In the example in FIG. 8C, the laser pattern 33-1 of laser light which is reflected on the clothes of the torso 31 of the intruder 30 and the laser pattern 33-2 of laser light which is reflected on the head 32 are brightly captured. In this example, as an example, a G brightness value is high in the laser pattern 33-1 of laser light which is reflected on the clothes of the torso 31, and R and G brightness is high in the laser pattern 33-2 of laser light which is reflected on the head 32.

Continuously, the laser pattern extraction unit 14d acquires the signal value of the pixel of each color from the color image depending on the intensity of the reflected light of the laser light of each of the R, G, and B colors, and extracts a laser pattern (step S4).

The intensity of the reflected light of the reflected light of laser light which is projected to the subject changes depending on the distance from the camera system 1 to the subject, and, in addition, a ratio of the intensity of reflected light of the R, G, and B differs in the respective colors of the subject. In FIG. 8C, for example, the intensity of the reflected light of the laser pattern of laser light which is irradiated to the background is extremely weak in all the R, G, and B, only the intensity of the reflected light of the R is strong in the torso 31, and the reflected light intensities of the R and G are strong in the head 32. In FIGS. 8C and 8D, laser patterns are expressed using a solid line, a dotted line, and a broken line in order of intensity of reflected light. In the signal processing unit 14, it is possible to extract a region, in which a subject to which laser light is actually irradiated is present, by setting a threshold in advance to, for example, the intensity of the reflected light of the laser pattern of each of the R, G, and B colors, that is, the signal value of the pixel. Thereafter, the position of each pixel included in the region and the signal value information (color information) of each of the R, G, and B of the pixel are written in the fourth memory 15d. Meanwhile, the threshold of the signal value of the pixel may be stored in a register or a Read Only Memory (ROM) which is not shown in the drawing and is included in the signal processing unit 14, or the fourth memory 15d.

Further, the image composition unit 14e colors the infrared image using the color information which is determined based on the intensity of the reflected light of the laser light of each of the R, G, and B colors.

As an example, the image composition unit 14e first detects a laser pattern, which is in the same region as the pixel of interest of the infrared image and has the closest distance, from the color image (step S5). This process is performed for each pixel of the infrared image.

Subsequently, the image composition unit 14e extracts the signal value of each of the R, G, and B of the laser pattern. In this process, the information is read and acquired from the fourth memory 15d which stores the signal value of each of the R, G, and B of the laser pattern (step S6).

In the examples in FIGS. 8A to 8E, to a pixel included in the region of the torso 31 in the infrared image 35A in FIG. 8B, the R, G, and B signal values of the laser pattern 33-1 (FIG. 8D) of the color image in which the distance between pixels is the closest in the region which includes the pixel are assigned. In addition, to a pixel included in the region of the head 32 in the infrared image 35A, R, G, and B signal values of the laser pattern 33-2 in which the distance between pixels is the closest in the region which includes the pixel are assigned. On the other hand, for example, the first memory 15a is referred to with regard to a brightness signal, and the signal value of the pixel corresponding to the infrared image 35 in FIG. 8A is assigned without change.

As described above, the image composition unit 14e determines a brightness signal Y and a color signal for each pixel of the infrared image. The color signal is converted from, for example, R, G, and B signals having the laser pattern into chrominance signals Cb and Cr, and a single frame composition image is generated using the brightness signal Y and the color difference signals Cb and Cr (step S7). The composition image is temporarily stored in a storage device such as, for example, a buffer memory which is not shown in the drawing or the non-volatile memory 17. Further, the image composition unit 14e sequentially outputs the brightness signal Y and the color difference signals Cb and Cr as the composition image during, for example, a blanking period in the IR mode of a subsequent frame period in accordance with a timing generator which is not shown in the drawing.

A final composition image (FIG. 8E) is acquired by performing back calculation on the color difference signals Cb and Cr and obtaining R, G, and B signals using a display device (not shown) to which the brightness signal Y and the color difference signals Cb and Cr are provided. As a result, in the example of the embodiment, for example, the region of the torso 31 in the infrared image 35 is colored using a red color and the region of the head 32 is colored using a yellow color (the color acquired by composing a red color and a green color). On the other hand, with regard to the background, intensity is weak together with R, G, and B signals, thereby being displayed using the dark color of an achromatic color.

The above-described operation is sequentially performed on continuous captured images in synchronization with the exposure and scanning of the imaging device 12. Therefore, it is possible to generate and display the composition image in real time at the same time that the infrared image and the color image are captured by the camera system 1.

Meanwhile, as described with reference to FIG. 3, the diffraction pattern of laser light is actually projected as the sequence of light spots. The example of the embodiment is designed such that light spots having a plurality of colors are adjacent to each other and arranged in a straight line. Further, the intensity of reflected light corresponding to each of the light spots which configure a single segment differs depending on a subject. Here, for example, the average of the intensity of the reflected light corresponding to each of the light spots which configure a segment for each R, G, and B colors of the extracted laser pattern is calculated, and the average is used as the signal value of each color of the laser pattern.

In addition, the color of the pixel of interest of the infrared image may be assigned by detecting a laser pattern which is the closest to the corresponding pixel in the same region as the pixel of interest of the infrared image, and using the R, G, and B signal values of the pixel having the laser pattern. In this case, with regard to the infrared image, it is possible to reproduce the color of the color image with higher accuracy.

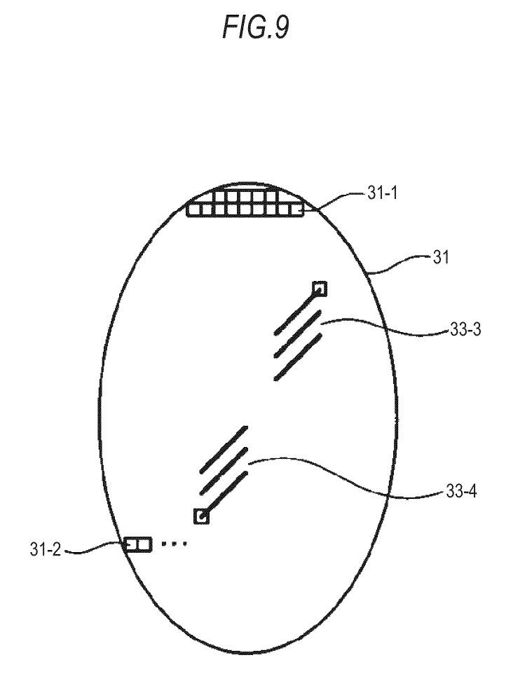

Here, the assignment of color when a plurality of laser patterns is present in a region which includes the pixel of interest of the infrared image will be described with reference to FIG. 9.

FIG. 9 is an explanatory diagram illustrating an example which detects a laser pattern which is the closest in the same region as the pixel of interest of the infrared image from the color image.

In this example, two laser patterns 33-3 and 33-4 are included in the region of the torso 31 of the infrared image. Since a pixel of interest 31-1 in the region of the torso 31 is closer to the laser pattern 33-3 than the laser pattern 33-4, the R, G, and B signal values of the laser pattern 33-3 are assigned. On the other hand, since a pixel of interest 31-2 in the region of the torso 31 is the closest to the laser pattern 33-4, the R, G, and B signal values of the laser pattern 33-4 are assigned.

Otherwise, a method of coloring the pixel of interest may be considered in such a way as to weight the R, G, and B signal values of each of a first laser pattern and a second laser pattern which are present in the same region depending on the distance from the pixel of interest, and to use the R, G, and B signal values of two laser patterns.

As the projected pattern is tight, in other words, as a large number of unit patterns which configure the projected pattern are included in division regions of the infrared image, it is possible to reproduce the color of the division regions in detail.

According to the above-described example of the first embodiment, the projected pattern of the visible laser light corresponding to a plurality of colors (in this example, three primary colors) is directly irradiated to the subject, and the intensity of the reflected light is detected, thereby coloring the infrared image. Therefore, in a case of image capturing when it is dark where there is no ambient light, it is possible to considerably improve color reproduction accuracy, compared to the related art.

On the other hand, since light which is irradiated to the subject is light beam having high directionality due to the laser pattern, it is difficult to recognize a surveillance region from the outside like an illumination lamp, and the leakage light of illumination does not bother neighborhood.

In addition, laser light is irradiated to human. However, since laser light is diffused using laser light reproduction hologram, it is possible to design a system which has not a safety problem.

Meanwhile, in the above-described example of the embodiment, laser light reproduction hologram is used to project the laser light pattern. The laser light is diffused, and thus this has the effect of causing the laser light pattern to be widely projected to the subject and securing safety when a person directly gazes the laser light source (laser light). However, in a case of a use that it is not necessary to pursuit the safety of the laser light source, it is possible to directly project laser light to the subject from the laser light source without using the laser light reproduction hologram. In this case, in order to widely project laser light pattern in the capture angle of view, the laser light source of each color is prepared in as many numbers of projected patterns or the number of unit patterns which configure the projected pattern.

In addition, in the above-described example of the embodiment, as the projected pattern of the laser light, the pattern in which a segment which is configured with the light spot of the laser light of each of the R, G, and B is projected at a 45-degree slant has been described. However, the projected pattern is not limited thereto, and other forms may be used in a case of a repetitive pattern in which at least two color patterns are adjacent. For example, as the projected pattern of laser light, a pattern may be used in which a plurality of light spots of laser light is arrayed for respective colors and in which unit patterns configured with adjacent respective color arrays are dispersed. It is possible to use a pattern other than a segment such as, for example, a broken line having a wide interval of laser light for each color or a curved line or a circle in a shape.

In addition, in the above-described example of the embodiment, the composition process is performed in such a way that the brightness signal of the pixel of interest of the infrared image is set to Y and the color difference signals of the pixel of the color image are set to Cb and Cr. However, a signal may be finally composed using another method. For example, instead of the YCrCb method, a YUV method may be used.

In addition, in the above-described example of the embodiment, the infrared image is prepared by projecting infrared light from the camera system 1. However, the present disclosure is not limited to this example. For example, it is possible to acquire the same function by using an image which captures infrared light which is directly and naturally emitted from the subject or using reflected light of infrared light due to ambient light without projecting infrared light.

In addition, in the above-described example of the embodiment, the imaging device is commonly used in the case in which the infrared image is acquired and the case in which the color image is acquired. However, an individual imaging device may be used in which the size of a captured image (the number of pixels) is the approximately same.

Further, in the above-described example of the embodiment, the camera system 1 in which the camera unit 10 and the projector unit 20 are integrally configured and the control unit 16 of the camera unit 10 which controls the projector unit 20 has been described as an example. However, the present disclosure is not limited to this example. The camera unit and the projector unit may be separately configured, and the projector unit may be operated independently from or in synchronization with the camera unit in response to a control signal from the outside.

### 2. Second Embodiment

In the first embodiment, as means for extracting color information about each pixel of the infrared image from the color image, the region division is performed on the infrared image, and the intensity of the reflected light of a laser pattern which is the closest to the pixel of interest in the region is referred to. A second embodiment shows an example in which the color image is reduced and color information is simply extracted using a reduced color image. Here, reduction of the number of pixels which configure an image is called image reduction.

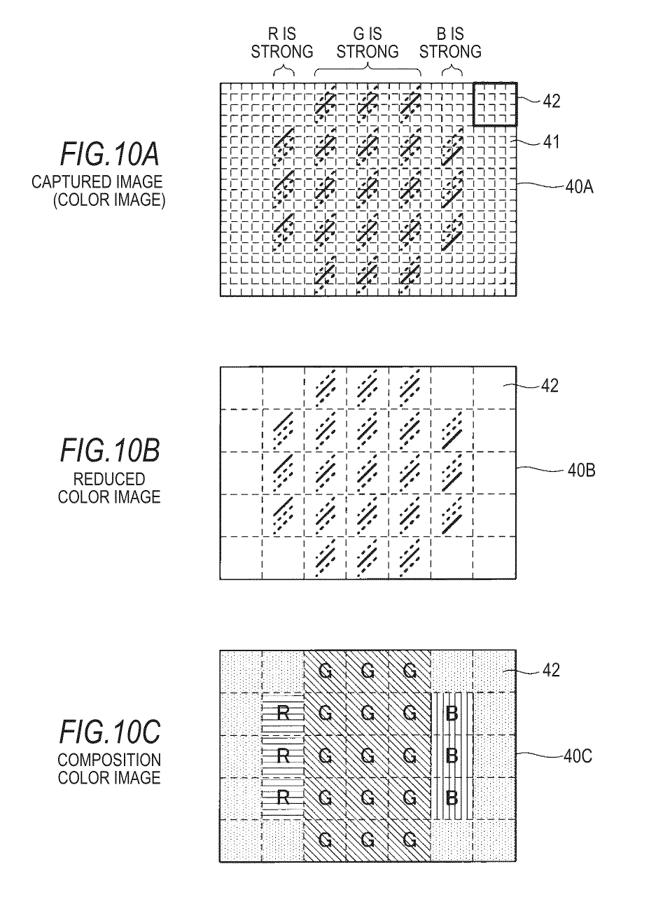

FIGS. 10A to 10C are explanatory diagrams illustrating processes to extract color information using a reduced image according to the second embodiment of the present disclosure.

First, the color image acquisition unit 14c (an example of an image reduction unit) performs a process to average the pixel values of a plurality of pixels 41 which are arranged in a matrix using a plurality of adjacent pixels with regard to a captured color image 40A. In an example shown in FIG. 10A, the process to average the pixel value of a 4×4 pixel is performed, and the color image 40A is reduced to a reduced color image 40B having the number of pixels of 1/16 (FIG. 10B). A pixel 42 of the reduced color image 40B corresponds to the 4×4 pixel of the color image obtained before the reduction.

At this time, it is preferable that a single combination of the R, G, and B laser patterns (for example, the unit pattern 26) be included in a single pixel of the reduced color image 40B, as shown in FIG. 10B, by adjusting the setting of the projector unit 20 of the camera system. Therefore, the laser pattern extraction unit 14d can extract a laser pattern corresponding to each pixel of the reduced color image 40B, and the image composition unit 14e can cause the color information of the laser pattern to correspond to each pixel of the reduced image (FIG. 10C).

Here, as shown in FIG. 10B, since each of the laser patterns of the three R, G, and B (each color) corresponds to the single pixel 42 of the reduced color image 40B by using the averaging process, division is not performed any more on the laser pattern for each light spot of laser light. Therefore, only the color information depending on the intensity of the reflected light of each of the R, G, and B of the laser pattern shown in FIG. 10B is assigned to each pixel. The image composition unit 14e can easily generate a composition color image 40C by combining the color information with the brightness information of each pixel of the corresponding infrared image.

In the example shown in FIG. 10A, in the laser patterns of the five columns on the color image 40A, red is strong in one column on the left, green is strong in the central three columns, and blue is strong in one column on the right. Therefore, in the composition color image 40C, green is assigned to the pixels of the central three columns, red is assigned to the pixels of the left side column thereof, and blue is assigned to the pixels of the opposite right side column. It is apparent that not only the three primary colors but also an intermediate color may be assigned depending on the colors of the extracted laser pattern.

According to the above-described second embodiment, it is possible to generate a simple composition color image by only generating a reduced color image based on a captured color image without performing a complicate image process.

Here, since a reduced color image is used with regard to color information, the resolution of the color information is lower than that of brightness information. However, for the purpose of a general surveillance camera, it is sufficient if the overall color information of a subject, such as the clothes or the car of an invader, may be understood. Therefore, the lack of detailed color information is not a problem.

### 3. Third Embodiment

In the first and the second embodiments, a fixed pattern is used as a laser pattern which is projected when a color image is captured. However, in a third embodiment, it is possible to extract color from the entire screen by performing an operation of scanning a laser pattern.

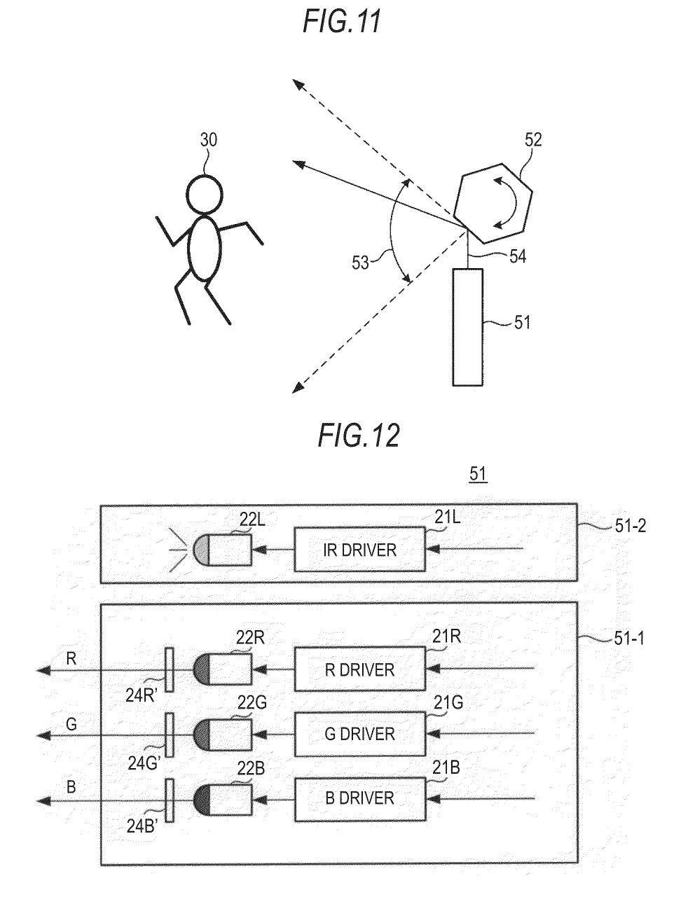

FIG. 11 is an explanatory diagram illustrating a camera system which extracts color from the entire screen by scanning a laser pattern to the entire angle of view area according to the third embodiment of the present disclosure. In addition, FIG. 12 is a configuration view illustrating an example of a projector unit according to the third embodiment of the present disclosure.

As shown in FIG. 11, the camera system according to the third embodiment includes at least a projector unit 51, a polygon mirror 52 (an example of the scanning unit), and a camera unit 10. The description of the camera unit 10 is omitted in FIG. 11. The other configurations are the same as those of the camera system 1 shown in FIG. 1.

The projector unit 51 includes a laser light projector system 51-1 and an infrared light projector system 51-2. The internal configuration of the laser light projector system 51-1 is almost the same as that of the laser light projector system of the projector unit 20 shown in FIG. 1, and hologram plates 24R′, 24G′, and 24B′ are arranged in front of the R, G, and B laser light sources 22R, 22G, and 22B. However, a laser pattern which is generated via the hologram plates 24R′, 24G′, and 24B′ is different from that shown in the example according to the first embodiment. The laser pattern is slit light as shown in FIG. 13.

FIG. 13 is an explanatory diagram illustrating the slit light, which is generated via the hologram plates, and a capture angle of view.

R, G, and B laser light emitted from the R, G, and B laser light sources 22R, 22G, and 22B is converted into slit light 54R, 54G, and 54B using the hologram plates 24R′, 24G′, and 24B′. The R, G, and B slit light 54R, 54G, and 54B are adjacent to each other, and irradiated to the entire angle of view area 27 in the light axis direction of the lens 23 (FIG. 2).

Further, the polygon mirror 52 is arranged in front of the laser light projector system 51-1, and the polygon mirror 52 rotates at a predetermined speed. The R, G, and B slit light 54R, 54G, and 54B which are emitted from the laser light projector system 51-1 are reflected in the polygon mirror 52 and irradiated to a subject (for example, an intruder 30). Further, the entire angle of view area 27 is scanned due to the rotation of the polygon mirror 52. Here, the arrangement position of the polygon mirror 52 is adjusted such that a scanning range 53 includes the angle of view area 27 as shown in FIGS. 11 and 13, and to synchronize with an operation of the exposure and reading of the imaging device 12. Meanwhile, the cross-sectional shape of the polygon mirror 52 in the example is an almost hexagon, the other polygons may be used.

On the other hand, infrared light which is emitted from the infrared light projector system 51-2 is not reflected in the polygon mirror 52, and directly irradiated to the entire angle of view area 27 like the first embodiment.

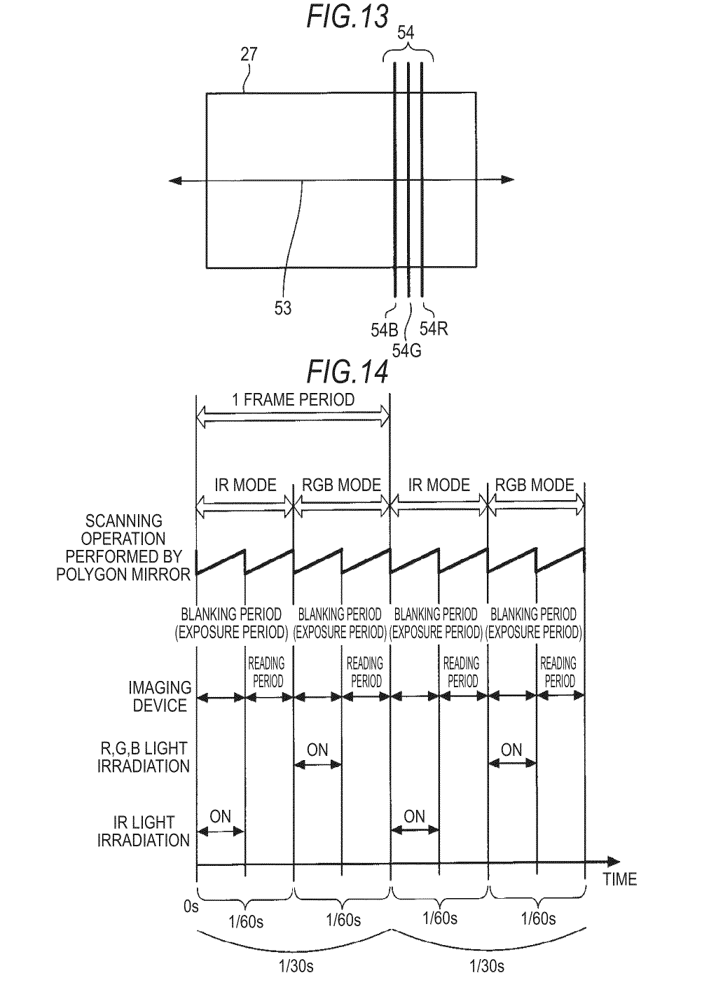

FIG. 14 is a sequence view illustrating an example of an operation of the imaging device according to the third embodiment of the present disclosure, and shows the relationship between a scanning timing of the slit light 54, which includes R, G, and B, and an exposure and reading timing of the imaging device 12.

Like the first embodiment, a single frame period (for example, 1/30 sec) that the camera system generates a single image (single frame) is divided into two, that is, an IR mode and an RGB mode, and the imaging device 12 performs scanning for a single screen in each of the IR mode and the RGB mode.

When scanning is performed using the slit light 54 and the polygon mirror 52, it is necessary to equivalently project the slit light 54 to each position in the angle of view area 27 of the camera unit 10. Therefore, setting is made such that one-round scanning is completed during the blanking period (exposure period) of the imaging device 12. During the blanking period, each pixel of the imaging device 12 receives reflected light of laser light of each of the R, G, and B colors at equivalent time intervals in accordance with the passages of the slit light 54.

In addition, the polygon mirror 52 is normally rotated continuously when an image is being captured. Since the irradiation of the R, G, and B laser patterns is performed during only the blanking period in the RGB mode, the R, G, and B laser light sources 22R, 22G, and 22B are turned off during the other periods. Therefore, the imaging device 12 can acquire an image which is equivalent to the R, G, and B slit light 54 being irradiated to the entire angle of view area 27 during a single scanning period (a scanning period using one surface of the polygon mirror 52).

According to the third embodiment which is configured as described above, the camera system is different from that of the first embodiment, and each pixel of the infrared image can include brightness information and R, G, and B color information each corresponding thereto. Therefore, the signal processing unit 14 can generate a composition color image by simply extracting the brightness information (the brightness signal Y) from the infrared image for each pixel, extracting the color information (for example, the color difference signals Cb and Cr) from the color image, and composing the brightness information and the color information. That is, compared to the first embodiment, the process to assign the color information is simple.

Meanwhile, in the above-described embodiment, the polygon mirror is used for the operation of scanning laser light. However, another scanning device, such as a Micro Electro Mechanical System (MEMS) mirror, may be used.

In addition, in the above-described embodiment, slit light which is generated using the hologram plates as projection patterns is irradiated. However, another projection patterns may be used. For example, the scanning operation may be performed on the entire capture angle of view using a movable mirror which is capable of 2-dimensional scanning in the X and Y directions using spot light source instead of the hologram plates.

In addition, in the above-described embodiment, the hologram plates are used as an example of the scanning unit. The present disclosure is not limited thereto if a device which can convert laser light into slit light is used. For example, a cylindrical lens may be used.

In addition, for example, the third embodiment may be applied to the first embodiment, and thus the color information which is acquired by irradiating slit light to the entire angle of view area may be assigned to the division regions of the infrared image. In addition, the third embodiment may be applied to the second embodiment, and thus a reduced color image may be generated using the color information which is acquired by irradiating slit light to the entire angle of view area, and the color information may be added to the infrared image.

### 4. The Others

In the above-described first to third embodiments, the case in which the moving images are captured using infrared light when it is dark, that is, there is no ambient light which has been described as an example. However, it is apparent that the above-described first to third embodiments can be applied when still images are captured.

In addition, the region division is performed on the infrared image in the first embodiment. However, the color information which is determined depending on the intensity of the reflected light of visible laser light may be provided to each pixel of the infrared image without performing the region division on the infrared image. In this case, the segmentation processing unit 14b is not necessary. For example, the color information is assigned to the pixel of interest of the infrared image based on the intensity of the reflected light of visible laser light having a laser pattern which is the closest to the pixel of interest of the infrared image in the color image.

Further, a camera system which attains the advantage of the present disclosure may be configured by appropriately combining the above-described first to third embodiments.

For example, in the first embodiment, the fact that the color information, obtained when the intensity of the reflected light of laser light which is reflected from a subject is equal to or greater than a threshold, is used for image composition may be applied to the second and third embodiments.

In addition, in the first embodiment, the fact that the pixel of interest of the infrared image and a laser pattern which is the closet to a pixel in which the laser pattern of the color image is present in a region which includes the pixel of interest is extracted and the color information thereof is used may be applied to the second and third embodiments.

The present disclosure may also be configured as follows.

(1) An imaging apparatus includes: an imaging device that images an infrared image using reflected light from a subject to which infrared light is irradiated, and, in addition, images a color image using the reflected light from the subject to which patterns formed by combining a plurality of colors of visible laser light are projected; and a signal processing unit that colors the infrared image using color information which is determined depending on an intensity of the reflected light of the plurality of colors of visible laser light from the color image.

(2) In the imaging apparatus of (1), the signal processing unit includes: a region division unit that divides the infrared image which is captured by the imaging device into a plurality of regions depending on the intensity of the reflected light of the infrared light which is received by each pixel of the imaging device; a laser pattern extraction unit that extracts a laser pattern by acquiring the intensity of the reflected light of the plurality of colors of visible laser light from the color image which is captured by the imaging device; and an image composition unit that generates a composition image by assigning a color to a region of the infrared image, which is at a position corresponding to the laser pattern of the color image, based on the color information determined depending on the intensity of the reflected light of the plurality of colors of visible laser light which is extracted by the laser pattern extraction unit.

(3) In the imaging apparatus of (1) or (2), in the patterns which are formed by combining the plurality of colors of visible laser light, unit patterns, which include a plurality of light spots arranged for respective colors of the visible laser light and include adjacent arrays of the respective colors, are dispersed.

(4) In the imaging apparatus of (2) or (3), the laser pattern extraction unit acquires a pixel in which the intensity of the reflected light of the visible laser light is equal to or greater than a threshold for each color from the color image and the intensity of the reflected light of the visible laser light for each color of the pixel.

(5) In the imaging apparatus of any one of (2) to (4), the image composition unit extracts a pixel of interest of the infrared image and a laser pattern which is the closest to a pixel having the laser pattern of the color image in a region in which the pixel of interest is included, determines the color information based on the intensity of reflected light of the plurality of colors of visible laser light included in the extracted laser pattern, and assigns a color to the pixel of interest.

(6) In the imaging apparatus of (3) or (5), at least one unit pattern of the patterns which are formed by combining the plurality of colors of visible laser light, is dispersed so as to be included in the region obtained through the division performed on the infrared image.

(7) In the imaging apparatus of any of (1) to (6), the imaging device performs imaging using a first mode which acquires the infrared image and imaging using a second mode which acquires the color image during a single frame period, and the signal processing unit generates a single frame composition image using the infrared image and the color image which are captured during the single frame period.

(8) In the imaging apparatus of any of (2) to (7), the image composition unit generates a reduced color image in which the number of pixels is reduced by composing the color information of the pixels positioned to be adjacent to each other in the color image, and assigns the color information of each of the pixels of the reduced color image to a corresponding region of the infrared image.

(9) In the imaging apparatus of (8), the unit patterns of the patterns which are formed by combining the plurality of colors of visible laser light are dispersed so as to correspond to the respective pixels of the reduced color image.

(10) The imaging apparatus of any of (1) to (9) further includes a scanning unit that scans the pattern which includes the adjacent plurality of colors of visible laser light over an entire angle of view area.

(11) In the imaging apparatus of any of (1) to (10), the plurality of colors of visible laser light includes red color laser light, green color laser light, and blue color laser light.

(12) In the imaging apparatus of any of (2) to (11), the laser pattern extraction unit extracts a color difference signal as the color information of a pixel which corresponds to the pattern from the color image, and the image composition unit generates the composition image using a brightness signal depending on the intensity of the reflected light of a corresponding pixel of the infrared image and the color difference signal.

(13) The imaging apparatus of any of (1) to (12) further includes a projector unit that irradiates the infrared light and the plurality of colors of visible laser light.

(14) An imaging method includes: imaging an infrared image using reflected light from a subject to which infrared light is irradiated using an imaging device; imaging a color image using the reflected light from the subject to which patterns formed by combining a plurality of colors of visible laser light are projected using the imaging device; and coloring the infrared image using color information which is determined depending on an intensity of the reflected light of the plurality of colors of visible laser light from the color image using a signal processing unit.

(15) A camera system includes: a projector unit that irradiates the infrared light and the plurality of colors of visible laser light; an imaging device that images an infrared image using reflected light from a subject to which the infrared light is irradiated from the projector unit, and, in addition, images a color image using the reflected light from the subject to which patterns formed by combining the plurality of colors of visible laser light from the projector unit are projected; and a signal processing unit that colors the infrared image using color information which is determined depending on an intensity of the reflected light of the plurality of colors of visible laser light from the color image.

Meanwhile, although a series of processes in the example of each of the above-described embodiments can be performed using hardware, the series of processes can also be performed using software. When the series of processes are performed using software, the series of processes can be performed by a computer in which a program included in the software is embedded in dedicated hardware, or a computer in which a program used to perform various types of functions is installed. For example, a program included in desired software may be installed and performed in a general-purpose personal computer.

In addition, a recording medium (for example, the non-volatile memory 17) which records the program code of software to implement the function of each of the above-described embodiments may be provided to a system or an apparatus. In addition, it is obvious that the function may be implemented in such a way that the computer of the system or the apparatus (or a control device, such as a CPU, for example, the control unit 16) reads and executes the program code stored in the recording medium.

As the recording medium used to supply the program code in this case, for example, a flexible disk, a hard disk, an optical disk, a magneto-optical disc, a CD-ROM, a CD-R, a magnetic tape, a nonvolatile memory card, and a ROM can be used.

In addition, the functions of the above-described embodiments are implemented by executing the program code which is read by the computer. In addition, based on the instruction of the program code, an OS which runs on the computer performs a part of or the entire of an actual process. A case, in which the functions of the above-described embodiments are implemented depending on the process, is included.

In addition, in this specification, a process step in which a chronological process is described includes a process which is chronologically performed along the described order, and a process which is not necessarily chronologically processed and which is performed in parallel or individually (for example, a parallel process or a process based on an object).

Hereinbefore, the present disclosure is not limited to the above-described each embodiment, and it is apparent that various type of the other modification examples and application examples can be acquired without departing from the gist disclosed in the appended claims.

That is, since the example of each of the above-described embodiments is an appropriately detailed example of the present disclosure, technically preferable various limitations are made. However, the technical range of the present disclosure is not limited to the embodiments if there is no particular description of the gist of the limitation of the present disclosure in each description. For example, the used materials which are mentioned in the description below, the used amount thereof, processing time, processing order, and the numerical condition of each parameter are only preferred examples, and the dimension, the shape, and the arrangement relationship of each drawing used for the description are approximate.

The present disclosure contains subject matter related to that disclosed in Japanese Priority Patent Application JP 2012-088721 filed in the Japan Patent Office on Apr. 9, 2012, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An imaging apparatus comprising:
an imaging device that images an infrared image using reflected light from a subject to which infrared light is irradiated, and, in addition, images a color image using the reflected light from the subject to which patterns formed by combining a plurality of colors of visible laser light are projected; and
a signal processing unit that colors the infrared image using color information which is determined depending on an intensity of the reflected light of the plurality of colors of visible laser light from the color image.

2. The imaging apparatus according to claim 1,
wherein the signal processing unit includes:
a region division unit that divides the infrared image which is captured by the imaging device into a plurality of regions depending on the intensity of the reflected light of the infrared light which is received by each pixel of the imaging device;
a laser pattern extraction unit that extracts a laser pattern by acquiring the intensity of the reflected light of the plurality of colors of visible laser light from the color image which is captured by the imaging device; and
an image composition unit that generates a composition image by assigning a color to a region of the infrared image, which is at a position corresponding to the laser pattern of the color image, based on the color information determined depending on the intensity of the reflected light of the plurality of colors of visible laser light which is extracted by the laser pattern extraction unit.

3. The imaging apparatus according to claim 2,
wherein, in the patterns which are formed by combining the plurality of colors of visible laser light, unit patterns, which include a plurality of light spots arranged for respective colors of the visible laser light and include adjacent arrays of the respective colors, are dispersed.

4. The imaging apparatus according to claim 2,
wherein the laser pattern extraction unit acquires a pixel in which the intensity of the reflected light of the visible laser light is equal to or greater than a threshold for each color from the color image and the intensity of the reflected light of the visible laser light for each color of the pixel.

5. The imaging apparatus according to claim 3,
wherein the image composition unit extracts a pixel of interest of the infrared image and a laser pattern which is the closest to a pixel having the laser pattern of the color image in a region in which the pixel of interest is included, determines the color information based on the intensity of reflected light of the plurality of colors of visible laser light included in the extracted laser pattern, and assigns a color to the pixel of interest.

6. The imaging apparatus according to claim 3,
wherein at least one unit pattern of the patterns which are formed by combining the plurality of colors of visible laser light, is dispersed so as to be included in the region obtained through the division performed on the infrared image.

7. The imaging apparatus according to claim 1,
wherein the imaging device performs imaging using a first mode which acquires the infrared image and imaging using a second mode which acquires the color image during a single frame period, and
wherein the signal processing unit generates a single frame composition image using the infrared image and the color image which are captured during the single frame period.

8. The imaging apparatus according to claim 2,
wherein the image composition unit generates a reduced color image in which the number of pixels is reduced by composing the color information of the pixels positioned to be adjacent to each other in the color image, and assigns the color information of each of the pixels of the reduced color image to a corresponding region of the infrared image.

9. The imaging apparatus according to claim 8,
wherein the unit patterns of the patterns which are formed by combining the plurality of colors of visible laser light are dispersed so as to correspond to the respective pixels of the reduced color image.

10. The imaging apparatus according to claim 1, further comprising:
a scanning unit that scans the pattern which includes the adjacent plurality of colors of visible laser light over an entire angle of view area.

11. The imaging apparatus according to claim 1,
wherein the plurality of colors of visible laser light includes red color laser light, green color laser light, and blue color laser light.

12. The imaging apparatus according to claim 1,
wherein the laser pattern extraction unit extracts a color difference signal as the color information of a pixel which corresponds to the pattern from the color image, and
wherein the image composition unit generates the composition image using a brightness signal depending on the intensity of the reflected light of a corresponding pixel of the infrared image and the color difference signal.

13. The imaging apparatus according to claim 1, further comprising:
a projector unit that irradiates the plurality of colors of visible laser light.

14. An imaging method comprising:
imaging an infrared image using reflected light from a subject to which infrared light is irradiated using an imaging device;
imaging a color image using the reflected light from the subject to which patterns formed by combining a plurality of colors of visible laser light are projected using the imaging device; and
coloring the infrared image using color information which is determined depending on an intensity of the reflected light of the plurality of colors of visible laser light from the color image using a signal processing unit.

15. A camera system comprising:
a projector unit that irradiates infrared light and a plurality of colors of visible laser light;
an imaging device that images an infrared image using reflected light from a subject to which the infrared light is irradiated from the projector unit, and, in addition, images a color image using the reflected light from the subject to which patterns formed by combining the plurality of colors of visible laser light from the projector unit are projected; and
a signal processing unit that colors the infrared image using color information which is determined depending on an intensity of the reflected light of the plurality of colors of visible laser light from the color image.
